(19) United States
(12) Patent Application Publication
(10) Pub. No.: US 2012/0049142 A1
(43) Pub. Date: Mar. 1, 2012

(54) GUARDRAIL TRASH SCREEN ASSEMBLY

(76) Inventor: CLIFFORD F. LILL, Hawthorne, NY (US)

(21) Appl. No.: 13/086,647

(22) Filed: Apr. 14, 2011

Related U.S. Application Data
(60) Provisional application No. 61/377,214, filed on Aug. 26, 2010.
(60) Provisional application No. 61/377,838, filed on Aug. 27, 2010.

(51) Int. Cl. E01F 15/00; F16B 2/02; F16B 2/20; A47G 5/00

(52) U.S. Cl. 256/13.1; 160/330

(57) ABSTRACT

A guardrail screen assembly connectable to a guardrail assembly is disclosed. The screen assembly includes at least one top rail member, guardrail attachment members for attaching opposing ends of the at least one top rail member to opposing guardrail posts, a bottom rail member, and a screen member, attached to the at least one top rail member and the bottom rail member, for preventing debris and animals from traveling to and from a roadway side of the guardrail assembly.

This application claims priority to the following U.S. Provisional Patent Applications by Clifford F. Lill, each of which is incorporated herein by reference in its entirety: Nos. 61/377,214 and 61/377,838, both for a Guardrail Trash Screen Assembly, respectively filed on Aug. 26, 2010 and Aug. 27, 2010.

### BACKGROUND OF THE DISCLOSED EMBODIMENTS

All too often, motorists discard trash on roads positioned near streams and other water bodies. Due to wind, rain or the momentum of being dropped from a moving vehicle, the trash travels off the road, down any adjacent embankment and into the water body. As can be appreciated, such waste can cause a significant environmental degradation, resulting in the loss of in-stream habitats for fish and other aquatic species and adverse impacts of the navigational capacity of waterways. If the water bodies are open reservoirs, the waste could cause an increased difficulty in filtering drinking water and the loss of drinking water reservoir storage capacity.

While preventing debris from leaving the roadway is a concern of the inventors, another concern is preventing wildlife from entering the roadway from the water-side. As an example reptiles such diamondback terrapins, will attempt to cross the road every spring, en-mass to lay eggs on higher ground. Unfortunately, the reptiles are no match for road traffic.

Not only is the grip between tires and the roadway compromised by the resulting reptile carcasses, but the reptile population is also impacted. Indeed, coastal roads are considered one of the top threats to these reptiles. Today, diamondback terrapins are declining drastically throughout their range, which extends from Cape Cod, Mass., south around the Florida coastline to the Texas-Mexico border. Despite their extensive distribution, they survive in isolated pockets among fragmented habitats; thus their total area of occupancy, and numbers, are relatively small, as observed by environmental groups.

It is an object of the disclosed embodiments to provide a structure which prevents trash from leaving roadways while also preventing wildlife from entering roadways. It is a further object that such structure would be readily connected to standard guardrails.

### SUMMARY OF THE DISCLOSED EMBODIMENTS

A guardrail screen assembly connectable to a guardrail assembly is disclosed. The screen assembly includes at least one top rail member, guardrail attachment members for attaching opposing ends of the at least one top rail member to opposing guardrail posts, a bottom rail member, and a screen member, attached to the at least one top rail member and the bottom rail member, for preventing debris and animals from traveling to and from a roadway side of the guardrail assembly.

### BRIEF DESCRIPTION OF THE FIGURES

In order that the manner in which the objectives of the invention are realized, a particular description of the invention will be rendered by reference to specific embodiments thereof that are illustrated in the appended drawings. The drawings depict only typical embodiments of the invention and are not therefore to be considered to be limiting of its scope. In particular:

FIG. 1A illustrates a front perspective view of top rails and screen clips utilized in a disclosed embodiment;

FIG. 1B illustrates front plan view of the top rails and screen clips;

FIG. 1C illustrates bottom elevational view of the top rails and screen clips;

FIG. 1D illustrates side elevational view of the top rails and screen clips;

FIG. 2A illustrates a front plan view of the left-hand rail component of the top rails;

FIG. 2B illustrates a bottom elevational view of the left-hand rail component of the top rails;

FIG. 2C illustrates a front plan view of the right-hand rail component of the top rails;

FIG. 2D illustrates a bottom elevational view of the right-hand rail component of the top rails;

FIG. 3A illustrates a side elevational view of the screen clip;

FIG. 3B illustrates a front plan view of the screen clip;

FIG. 4A illustrates a front perspective view of a guardrail screen assembly utilizing the disclosed components, assembled on a guardrail;

FIG. 4B illustrates a rear perspective view of the guardrail screen assembly disposed on a guardrail;

FIG. 4C illustrates a front elevational view of the guardrail assembly disposed on a guardrail;

FIG. 4D illustrates a top elevational view of the guardrail assembly disposed on a guardrail;

FIG. 4E illustrates a side elevational view of the guardrail assembly disposed on a guardrail;

FIG. 5A illustrates a top elevational view of an extension rail used in a second disclosed embodiment;

FIG. 5B illustrates a front plan view of the extension rail;

FIG. 6A illustrates a top elevational view of the extension rail in the second disclosed embodiment juxtaposed against the previously disclosed top rails;

FIG. 6B illustrates a front plan view of the extension rail in the second disclosed embodiment juxtaposed against the top rails;

FIG. 6C illustrates a side elevational view of the extension rail in the second disclosed embodiment juxtaposed against the top rails and including screen clips;

FIG. 7 illustrates the guardrail assembly disposed on a guardrail, with an additional screen on the lower portion of the assembly;

FIG. 8A illustrates a known clamp utilized in the guardrail assembly of the disclosed embodiments;

FIG. 8B illustrates a further view of the clamp utilized in the guardrail assembly of the disclosed embodiments; and

FIG. 8C illustrates a further view of the clamp utilized in the guardrail assembly of the disclosed embodiments.

### DETAILED DESCRIPTION OF THE DISCLOSED EMBODIMENTS

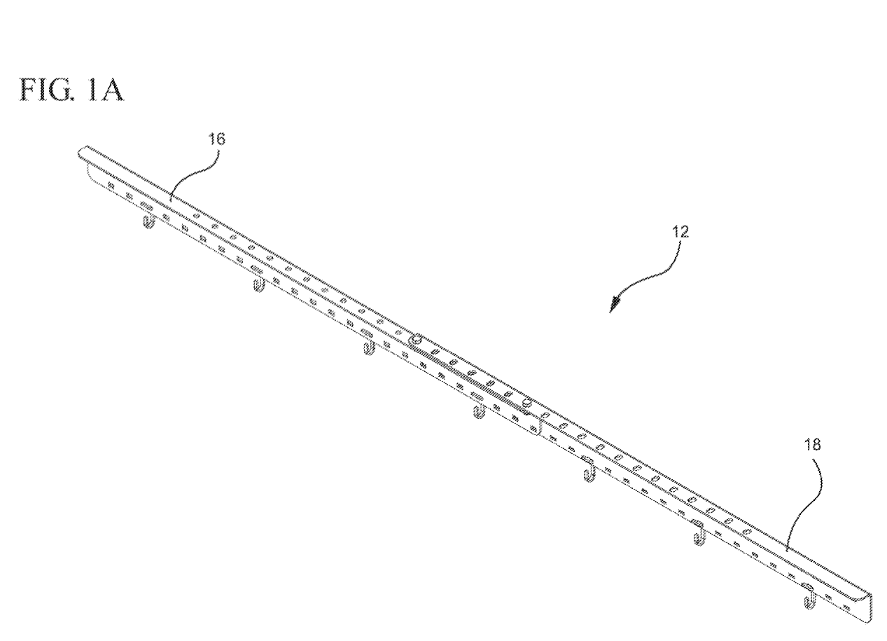

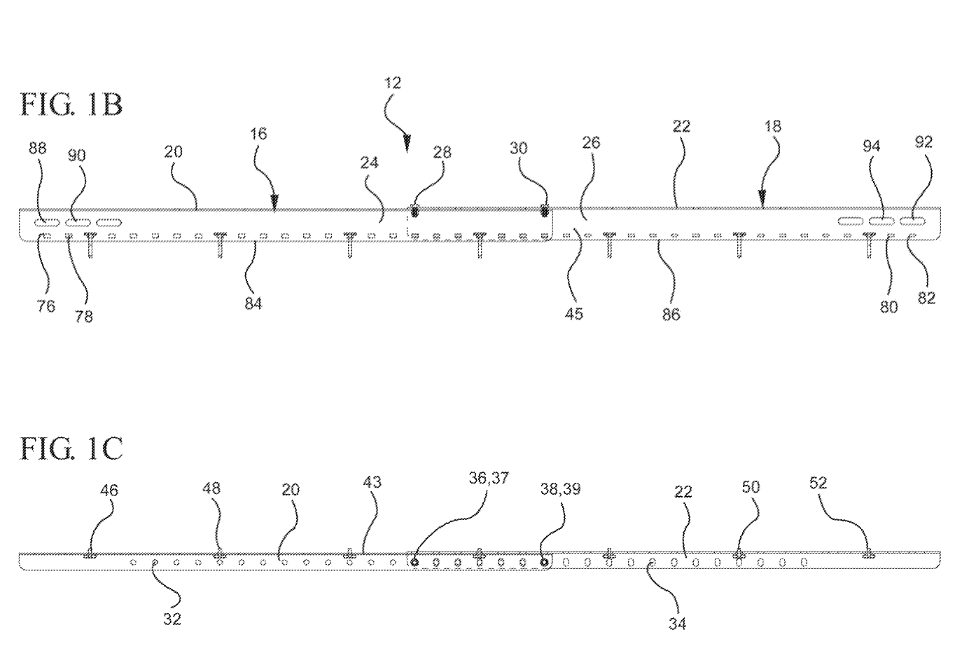

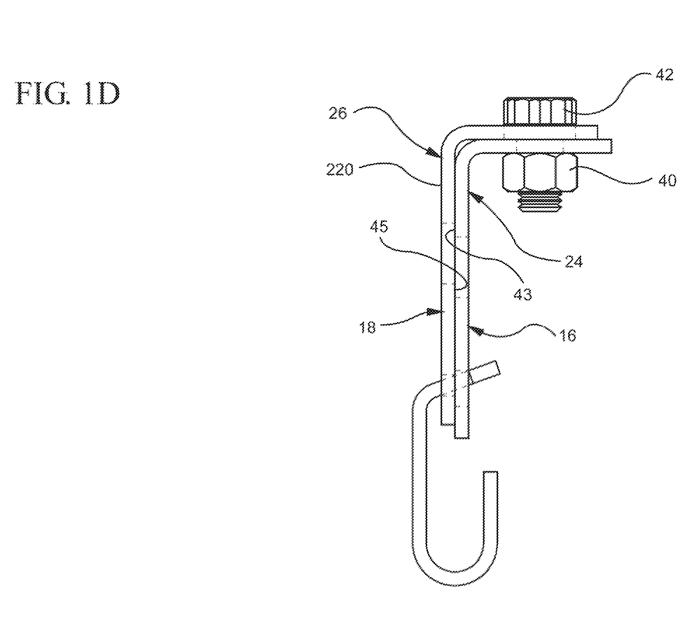

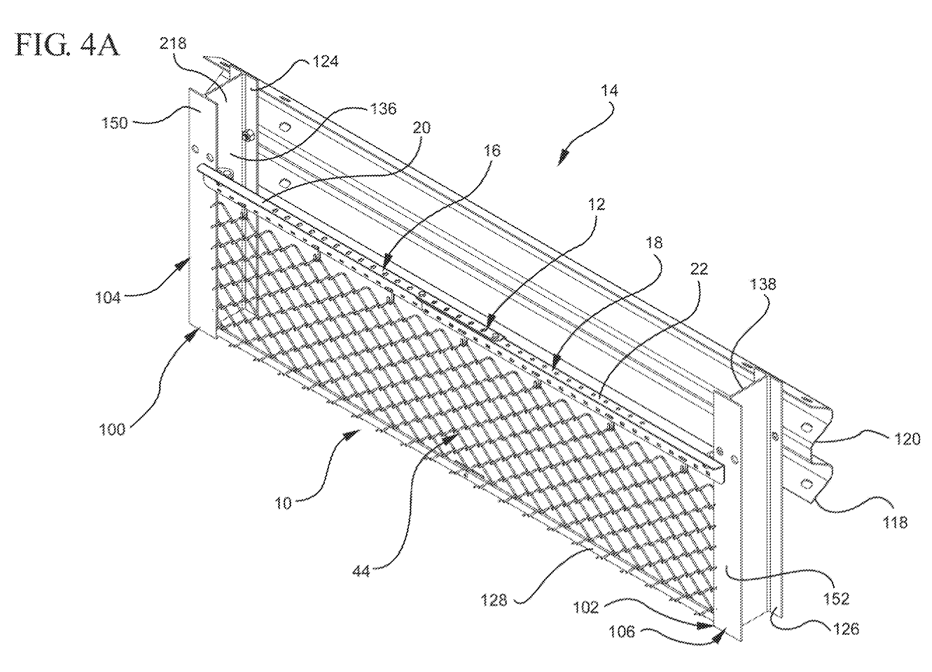

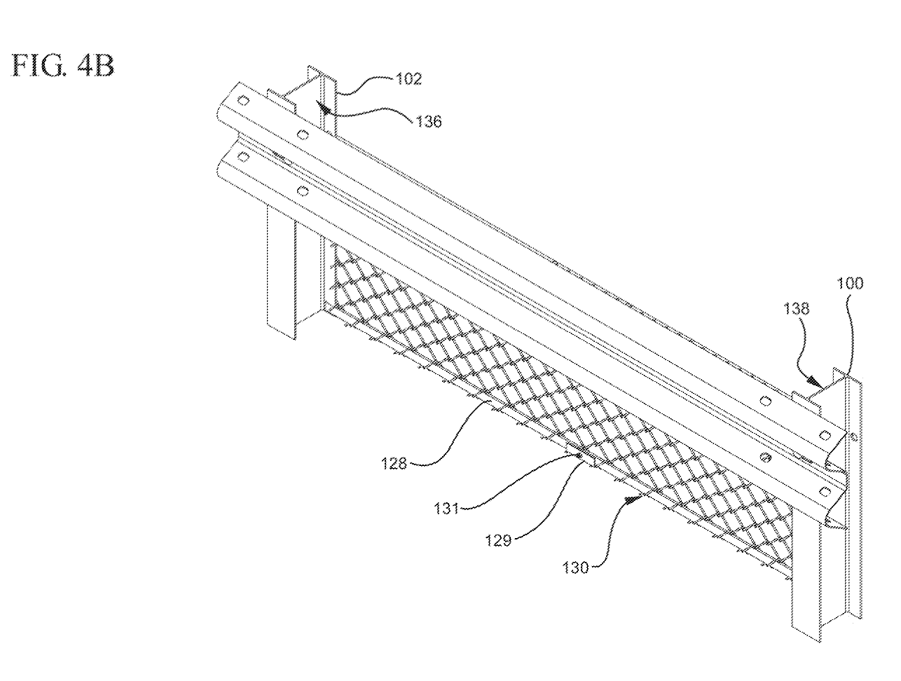

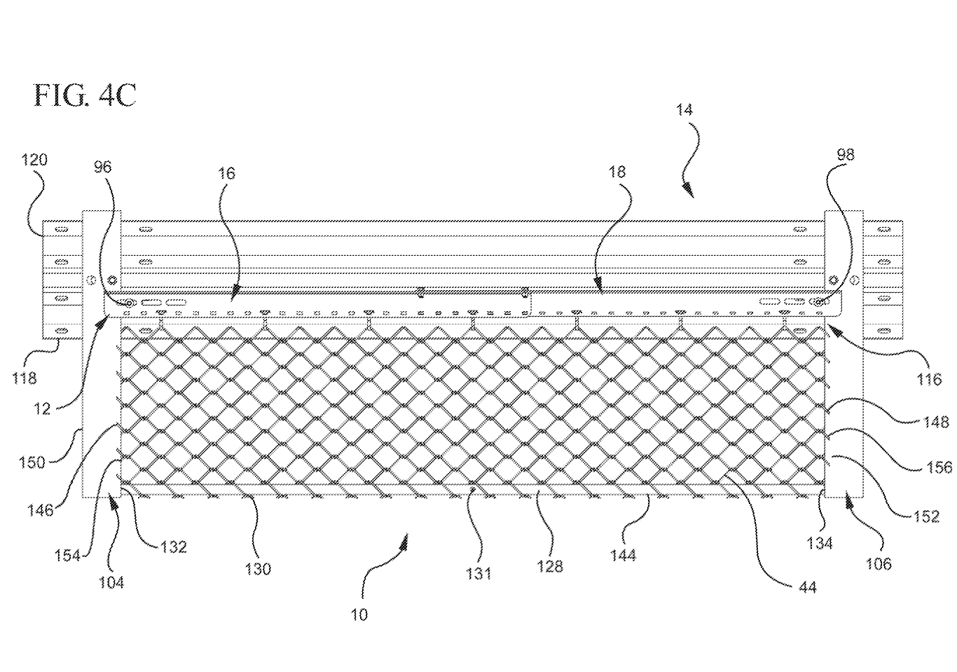

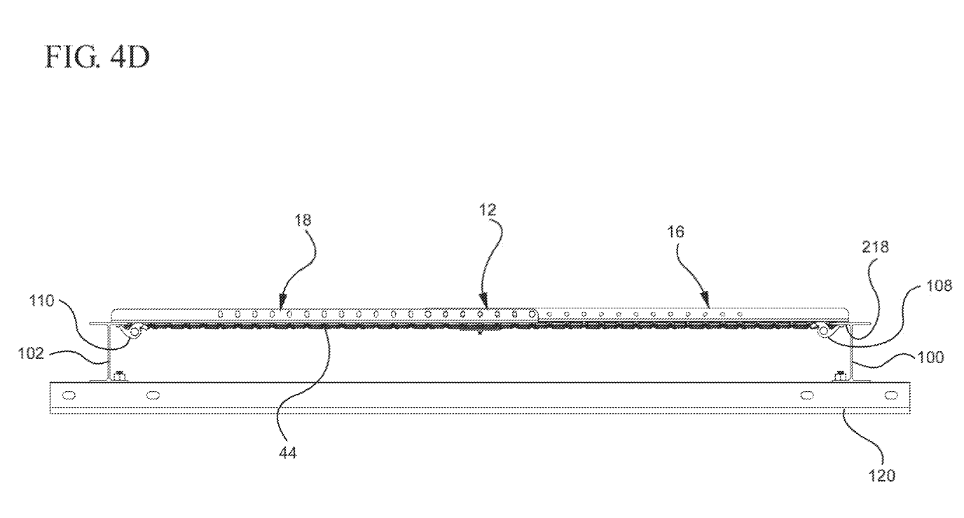

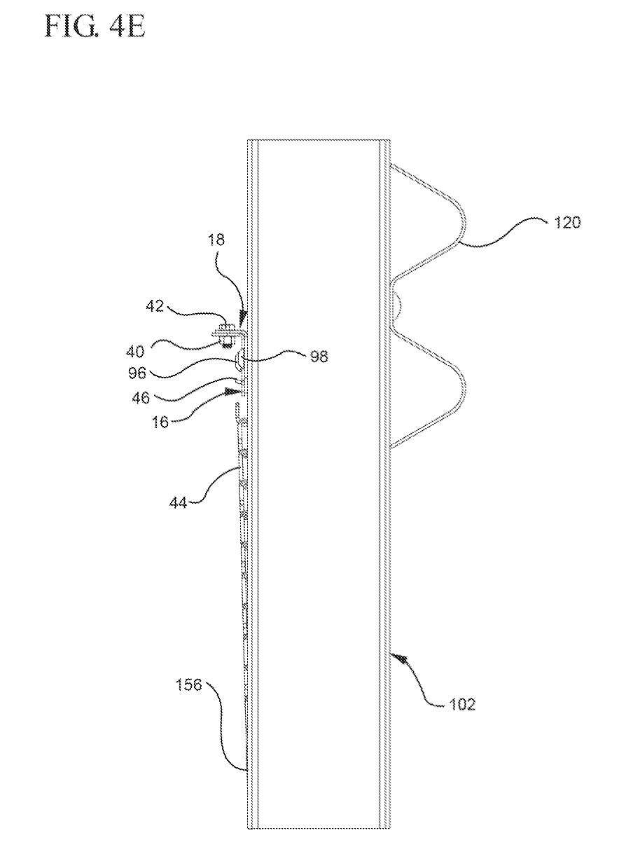

FIG. 4A illustrates the disclosed Guardrail Trash Screen Assembly 10 (hereinafter “screen assembly 10”), on a guardrail assembly 14, which is used to stop debris from exiting roadways and wildlife from entering roadways. FIGS. 1A-1D, 2A-2D and 4A-4E provide various illustrations of a same embodiment for an adjustable top rail assembly 12, and components thereof, for connecting the screen assembly 10 to a typical guardrail assembly 14.

The top rail assembly 12 contains two rail members 16, 18, having respective rail flanges 20, 22, where the flanges 20, 22 are substantially horizontal upon installation, and respective rail main bodies 24, 26, which form substantially vertical members upon installation. The rails 16, 18 can slide relative to each other in a rail longitudinal axis and can be fastened to each other on the rail flanges 20, 22 with respective rail connecting hardware 28, 30. One non-limiting example of a material suitable for the rails 16, 18 is A 588 COR-TEN Steel.

More specifically, the rail flanges 20, 22 each contain plural flange slots, e.g., 32, 34, 36-39. As the rails slide over, or are positioned against, each other during assembly, the slots overlap and are aligned such that, e.g., a minimum length of the flanges 20, 22 overlaps, providing a requisite rigidity to the unified top rail assembly 12. As a result, at least two flange slots 36-39 will overlap. Through selected flange slots 36-39, the rail connecting hardware 28, 30, comprising, e.g., a respective nut 40 and bolt 42 with, e.g., a lock-washer (not illustrated), will be connected.

Enough flange slots are provided to enable a variable connection for accommodating different guardrail systems. In the illustration, each rail is slightly larger than three and a half feet long, each flange is approximately an inch and a half deep, each having approximately twenty slots, offset towards centered in the depth-wise direction, and spaced at approximately two inches on center. The slots are lengthwise offset towards the center of the assembly 10 so that the length of overlapping for the flanges is about one foot. This provides an overall length of about seventy five inches for the assembled top rails 12. While this configuration is appropriate for many locations based on specific standards and regulation, this configuration is just one example and not meant to limit the disclosure.

While the shape of each flange slot on either rail is consistent, the shape of the flange slots, e.g., slot 32, on the first rail 16 is not the same as the shape of the slots, e.g., slot 34, in the second rail 18. This is because the flange slots will not align exactly in the area where the rails overlap. For example, rail 16, which in a front plan view of the screen assembly 10 is a left-handed rail, has a back face 43 which, when assembled, is against a front face 45 of rail 18, which is the right-handed rail. This offsets the spacing of the flanges from each other, and thus the slots 32, 34 by the thickness of the rails.

Accordingly, the rail 16 has circular slots, e.g., slot 32, with a diameter of less than half an inch. The slots, e.g., slot 34, on the right-handed rail 18 are elongated, having a radius matching the radius of the slots, e.g., slot 32, on the left-handed rail 16 and having an overall length of approximately three times the radius. This enables proper alignment of the flange slots 32, 34, when the flanges are positioned against each other.

The screen assembly 10 includes a screen 44 (FIG. 4A), which is, for example, a vinyl coated wire mesh fence. A suitable mesh fence is a 0.090 diameter (e.g., 12 gauge), two inch opening, chain-link fence. Other screen materials can be utilized which also prevent the passage of garbage, animals and turtles. The size of the screen 44 is discussed below.

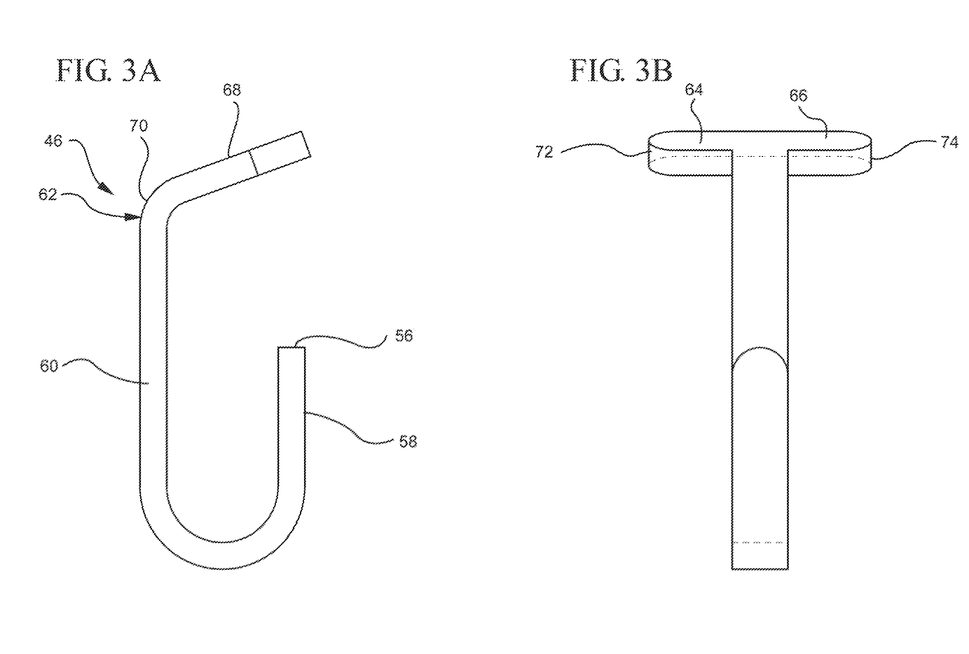

Plural screen clips, e.g., 46-52 (FIGS. 1C and 3A-3B) are utilized for connecting the screen 44 to the top rail assembly 12. The screen clips 46-52 are manufactured from A 588 COR-TEN Steel. Each screen clip includes a U-shaped hook section 54 having a free end 56 for receiving the screen 44 material. The free end-side of the hook 54 includes an elongated, substantially linear section 58 to enable a secure latching to the screen 44. For example, if the hook 54 has a radius of about a quarter of an inch, the length of the elongated section 46 is approximately half an inch.

On the opposite end of the hook section 54 is another elongated section 60, which extends parallel to, and past, the opposing free end 56 by approximately between one half and three quarters of an inch to a T-joint 62. The T-joint 62 returns towards the free end 56 by an acute angle, e.g., approximately seventy degrees, from the direction along the long axis of the elongated section 60.

The T-joint is approximately three quarters of an inch long, where the legs 64, 66 of the T-joint are in the last quarter inch of the joint 62 and an elongated return 68 defines the rest of the joint 62. The return 68 is connected to an end 70 of the elongated member 60 and is long enough to accommodate the double thickness of the vertical rail members 24, 26 in overlapping regions of the assembled top rails 12 (FIG. 1D). A total length of the Tin the T-joint, end to end 72, 74, is about an inch. The width of all parts of the clip is approximately a quarter of an inch.

The T-joint 62 enables each of the screen clips 46-52 to be inserted into rail clip slots, e.g., 76-82 (FIG. 1B) and effectively lock the clips 46-52 against the rail vertical members 24, 26. The elongated sections 58, 60 of the clips 46-52 are essentially parallel with the vertical when installed, while the hooks 54 are supporting the screen 44.

Regarding the clip slots, e.g., 76-82, as with the flange slots, enough clip slots 76-82 are provided for flexible positioning of the clips 46-52. In the illustration, the clips 46-52 are positioned in approximately every seventh of the clip slot 76-82.

The clip slots 76-82 are positioned near bottom edges 84, 86 of respective rail vertical members 24, 26 (see FIG. 1B). In the illustration, the spacing between clip slots 76-82 is the same as for the flange slots 32, 34, though the clip slots span the full length of the respective rails. The clip slots 76-82 are substantially rectangular, with the elongated portions running parallel with the long axis of the respective rails 16, 18, and are large enough for the T-joint to slip and out as required for installation and removal of the clips 46-52.

For the same reason the flange slots on the right-handed and left-handed rails 16, 18 differ in size, the clip slots 76-82 differ in size as well. That is, the clip slots 80-82 in the right-handed rail 18 overlap on the back side of the clip slots 76-78 in the left-handed rail 16 when the rails are stacked against each other.

Accordingly, while the clip slots 76-82 have approximately a consistent width, of about half an inch, the height of the clip slots 80-82 in the right-handed rail 18 is less than a quarter of an inch and are spaced from the bottom edge 86 by about a quarter of an inch. On the other hand, the height of the clip slots 76-78 in the left-handed rail 16 are larger, by about thirty percent, than the height of the clip slots 80, 82 in the right-handed rail 18. In addition, the spacing from the bottom edge 84 of the left-handed vertical member 24 to its clip slots 76, 78 is larger, by about ten percent, than the distance from the bottom edge 86 of the right-handed vertical member 26 to its clip slots 80, 82. This offset difference accommodates for the relative displacement between the slots in the rails due to the thickness of the stacked rails, as discussed earlier.

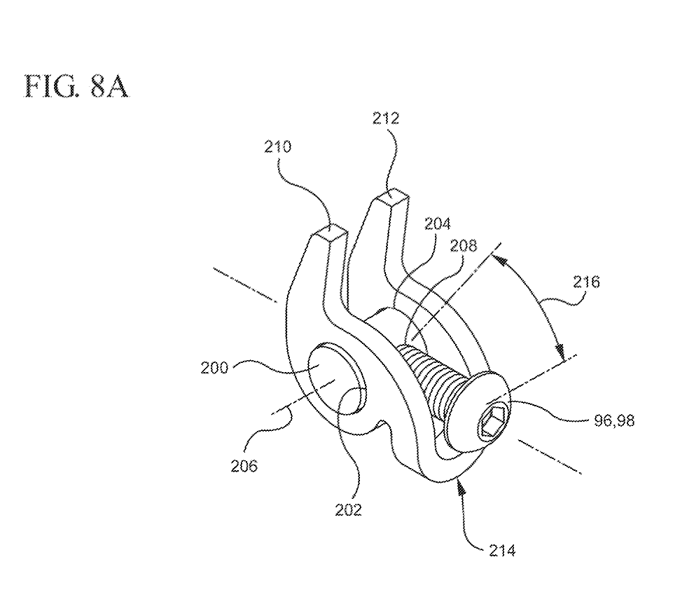

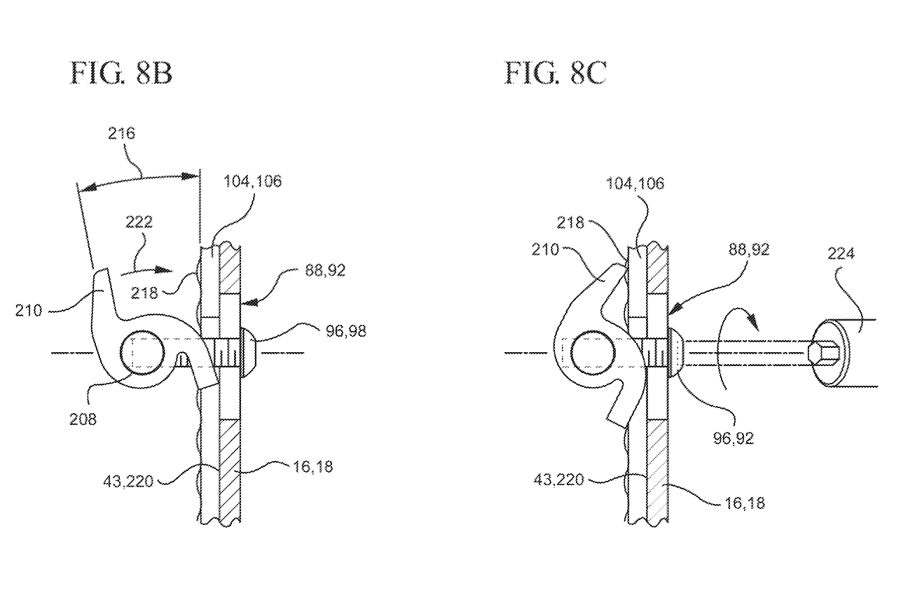

The rail vertical members 24, 26 have plural guardrail slots, e.g., 88-94 (FIG. 1B), positioned above the clip slots 76-82, closer to the respective rail flanges 20, 22. The guardrail slots 88-94 enable the pass-through of bolts 96, 98 (FIG. 8A) for connecting the rails to I-beam posts 100, 102 or the like which are part of standard guardrail assemblies 14, as illustrated in FIGS. 4A-4E.

More specifically, to connect the rails 16, 18 to a pair of opposing vertical flanges 104, 106 of the guardrail I-beam posts, opposing guardrail clamp means 108, 110 (FIG. 4E, 8A), with respective bolts 96, 98, are utilized, such as disclosed in U.S. Pat. No. 7,128,495, to Lill et al., granted Oct. 31, 2006, e.g., where the entire disclosure is incorporated herein by reference. Furthermore, relevant images and discussion of the clamp disclosed therein is provided herein for reference, as FIGS. 8A-8C, which have been modified for application in the presently disclosed embodiment.

In the illustrated configuration, the bolts 96, 98 of the clamp means 108, 110 are passed through outermost slots 88, 92 of the respective vertical members 24, 26 of the assembled top rails 12. When secured, the clamp means 108, 110 fasten the assembled top rails 12 against the guardrail I-beam posts 100, 102. As an alternative, the clamp means could be bolts secured directly to slots in the I-beam posts (not illustrated).

The guardrail slots 88-94 are formed at approximately one inch below the junction between the rail vertical members 24, 26 and the rail flanges 20, 22 so that hardware can be positioned and utilized without interference by the flanges. The guardrail slots 88-94 have a thickness of about a quarter of an inch, large enough for the shafts of the bolts to pass through (though not the heads of the bolts), and are about two inches in direction parallel to the longitudinal axis of the rails, enabling flexible placement of the clamp means 108, 110 as may be needed.

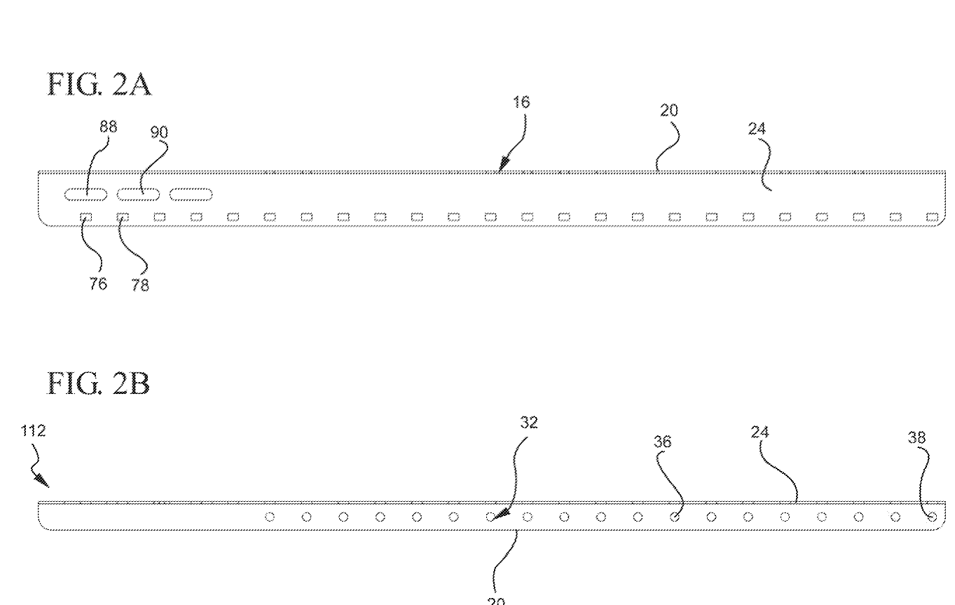

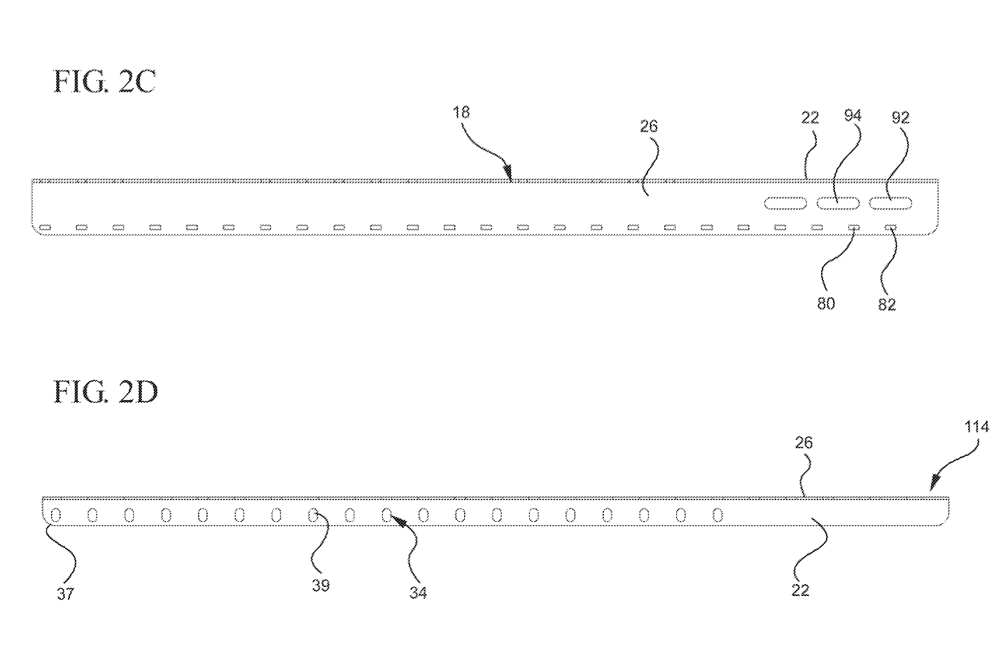

The guardrail slots 88-94 are biased towards respective outer ends 112, 114 (FIG. 2) of the top rails 16, 18, closer to the connection between the assembled top rails 12 and the posts 100, 102. That is, the guardrail slots 88, 90 on the right-handed rail 18 are biased towards the right while the guardrail slots 92, 94 on the left-handed rail 16 are biased towards the left.

Each rail vertical member 24, 26 has plural such guardrail slots 88-94, aligned along the longitudinal axis of the top rail assembly 12, mutually spaced by approximately two and a half inches. The additional guardrail slots 88-94 are provided to enable adjustably positioning the rails 16, 18 on post 100, 112. For example, top rail ends 112, 114 may need to overhang past the end of a post, depending on the circumstance.

It is to be appreciated that the right-handed rails 18 and left-handed rails 16 have the same sized guardrail slots 88-94. This is because these guardrail slots 88-94 do not overlap in the assembled top rails 12 (see FIG. 4A).

As illustrated in FIG. 4C, the assembled top rails 12 of the screen assembly 10 are positioned against the guardrail assembly 14 such that a top level 116 of the screen 44, and thus the assembled top rails 12, are above a bottom edge 118 of the standard horizontal guardrail 120 of the guardrail assembly 14. This positioning prevents essentially all debris, capable of being blocked by the screen 44, from passing through the guardrail assembly 14, under the guardrail 120 and between the posts 100, 102.

As the assembled top rails 12 are supported by the rear flanges 104, 106 of the posts 100, 102. This enables positioning the top rails 12 above the bottom edge 118 of the horizontal guardrail 120. This is because the horizontal guardrail 120 is connected to the front flanges 124, 126 of the posts 100, 102.

A bottom rail member 128 is included (FIG. 4A-4C) which is manufactured from 11 gauge, A 588 COR-TEN Steel, and which has a rectangular cross section of about an inch in height. The bottom rail 128 is passed through each loop in the bottom segment 130 of the screen 44. The bottom rail 128 provides shape to the screen 44 and, by its weight and stiffness, anchors the screen 44 to the bottom of the guardrail assembly 14, at the ground.

To maintain the placement of the bottom rail 128 in the screen, the bottom rail 128 includes a fastener, e.g., with a plate 129 and bolt 131, to the bottom rail. The plate 129 can have a height similar to the rail 128 and a longitudinal dimension which is great enough to cover a portion of the chain links (see FIG. 4B).

On the other hand, the bottom rail 128 is not bolted to the guardrail assembly 14, but is a unitary member, longer than the distance between mutually facing edges 132, 134 of opposing guardrail I-beam flanges 104, 106. This prevents the bottom rail 128 from swinging out of the c-channels 136, 138 created between opposing front and rear flanges in the adjacent I-beam posts 100, 102 of the guardrail assembly 14. As a result, animals and turtles will be unable to enter the roadway. Discarded waste will also be prevented from leaving the roadway and entering the natural habitat for the animals and turtles.

The screen assembly 10 can be connected to the I-beam posts 100, 102 after its complete assembly. Alternatively, the rails 16, 18, after being interconnected, but before introducing the screen 44 and screen clips 46-52, can be connected to the I-beam posts 100, 102 of the guardrail 14. Thereafter, the screen 44 and screen clips 46-52 can be connected.

It is to be appreciated that the height-size of the screen 44, between opposing height-wise ends 116, 130 (FIG. 4), is such as to cover the entire open area, from the rear plan view of the guardrail assembly, between the screen clips 46-52 and the bottom 144 (i.e., ground facing surface) of the bottom rail 128. Similarly, the width-size of the screen 44, between opposing width-wise ends 146, 148, is greater than the width-size opening between the facing edges 132, 134 of the flanges 100, 102, i.e., matching the length of the bottom rail 128.

In addition, the assembled top rails 12 are illustrated as being mounted to the rear-exterior side 150, 152 of the rear flanges 104, 106. As illustrated, the vertical members 24, 26 of the top rails 16, 18 are against the posts 100, 102 and the horizontal flanges 20, 22 extend away from the posts 100, 102 and away from the guardrail 120.

With the bottom rail 128 disposed in the c-channels 136, 138, the screen transitions between the interior and exterior of respective c-channels 136, 138 at transition points 154, 156, (FIG. 4C, 4F) which are close to the ground level. Positioning the transition points 154, 156 near the ground minimizes the material of the screen 44 within the c-channels 136, 138 of the I-Beams 100, 102. This minimizes the play for the bottom rail 128 within the c-channels 136, 138.

Alternatively, the assembled top rails 12 could be mounted on the interior side of the c-channels 136, 138, on the same posts 100, 102. In this configuration, the bottom rail 128 could be, e.g., on the rear-side of the posts 150, 152. Yet alternatively, the entire assembly 10 could be on either the exterior or interior side of the posts 100, 102, and the screen 44 could be clipped at a height-wise position near the ground to prevent extensive movement of the bottom rail 128.

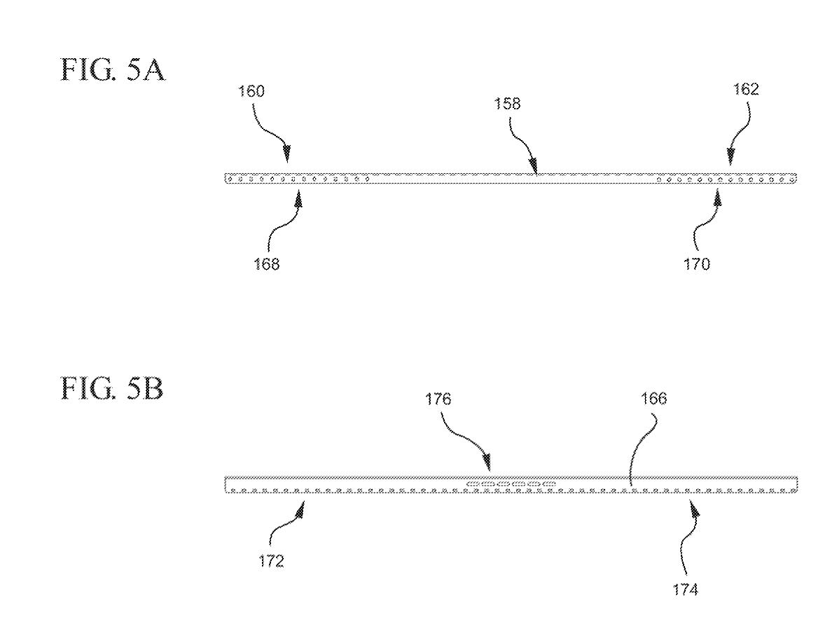

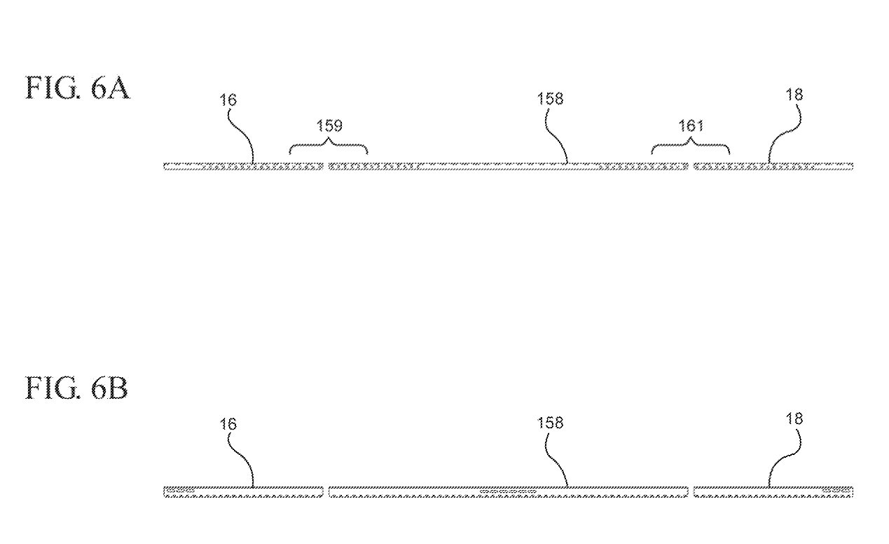

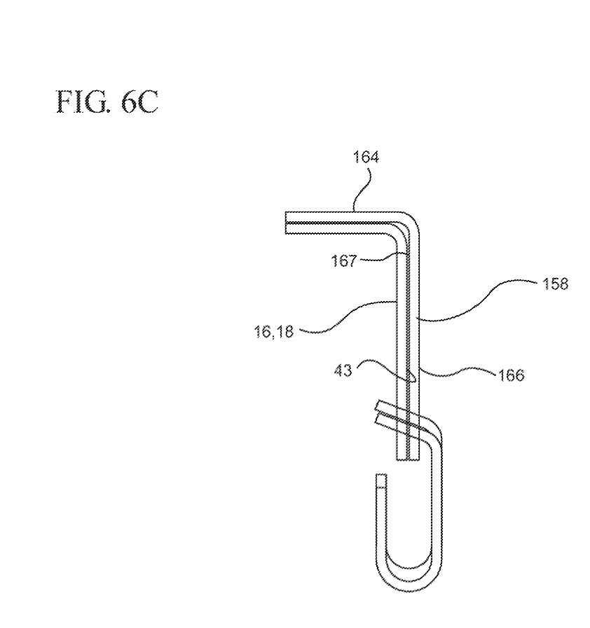

FIGS. 5A-5B and 6A-6C are directed to the inclusion of an extension rail 158 between first and second top rails 16, 18, such that the assembled top rails 12 would include three rails instead of two. It is to be noted that FIGS. 6A-6C illustrates the three rails in a juxtaposed configuration, while in practice they would be connected to each other.

The extension rail 158 is sized such that, including a left overlapping area 159, between the left rail 16 and the extension rail 158, and a right overlapping area 161, between the right rail 18 and the extension rail 158, the total length of the assembled top rails 12 would be approximately one hundred and fifty inches. This is because in certain geographic locations, due to location constrains and/or local regulations, the distance between posts 100, 102 could be twice the distance disclosed with the previous configuration.

The extension rail 158 has a similar cross-sectional shape as the first two rails 16, 18. That is, as with the first two rails 16, 18, the extension rail 158 has a horizontal flange member 164 and a vertical body member 166. However, as illustrated in FIG. 6C, the extension rail flange 164, in the depth-wise direction, and the vertical member 166, in the height-wise direction, are slightly larger, by about an eighth of an inch, than those parts of the first two rails 16, 18. In addition, when assembled, a back surface of both the first two rails 16, 18 (e.g. surface 43 of rail 16) are against a front surface 167 of the extension rail 158.

The difference in the depths of the flanges and the height of the vertical members is equivalent to the thickness of the material of the rails 16, 18, 158. This enables the depth-wise edges of the flanges to terminate in one plain and the height-wise edges of the vertical members to terminate in another plain, as illustrated in FIG. 6C.

The extension rail 158 includes two sets or banks 168, 170 of approximately a dozen flange slots, each spread over approximately two feet on respective longitudinal ends 160, 162. The left-handed bank of flange slots 168 has the same shape and distribution as the flange slots in the right-handed rail 18. Furthermore, the right-handed bank of flange slots 170 has the same shape and distribution as the flange slots in the left-handed rail 16. This enables the extension rail 158 to fit against the other rails 16, 18 as such would fit against each other.

As indicated, the flange slots 168, 170 are not distributed about the entire length of the flange 164. This is because the overlapping at opposing ends 160, 162 need only occur over a limited span to achieve a proper lengthwise dimension and obtain proper structural support.

The extension rail 158 includes two banks 172, 174 of clip slots, where the first bank 172 is spread over the left half of the vertical member 166 of the extension rail and the second bank 174 is spread over the right half of the vertical member 166 of the extension rail. The left-handed bank of clip slots 172 has the same shape and distribution as the clip slots 80, 82 in the right-handed rail 18. Further, the right-handed bank of clip slots 174 has the same shape and distribution as the clip slots 76, 78 in the left-handed rail 16. This provides the same benefit as with the flange-slot configuration discussed in the previous paragraph.

The clip slots are distributed about the entire length of the extension rail 158 so that the two banks 172, 174 terminate at the longitudinal center of the rail 158. This is because it is preferable that the screen 44 is supported along its entire length.

The extension rail 158 includes a bank 176 of guardrail slots, spread symmetrically about the longitudinal center of its vertical member 166. The bank of guardrail slots 176 has the same shape and distribution as the guardrail slots 88-94 in the rails 16, 18. The central guardrail slots 176 are provided so that the extension guardrail 158 can be clipped to and sported by an additional post (not illustrated) located intermediate of the spaced posts 100, 102. Approximately six guardrail slots are provided in the bank of guardrail slots 176 in the extension rail 158 for an adjustable clamping of the extension rail 158 to a post.

It is to be appreciated that the screen 44 would remain a unitary member in the configuration which utilizes an extension rail 158. Accordingly, screen lengths of one hundred and fifty inches would be applicable. Similarly, the bottom rail 128 can be fabricated to cover the entire span of the assembled top rails 12, or can be segmented as may be needed. If the bottom rail 128 is segmented, plural bottom rail fasteners with associated plates and bolts 129, 131 would be needed.

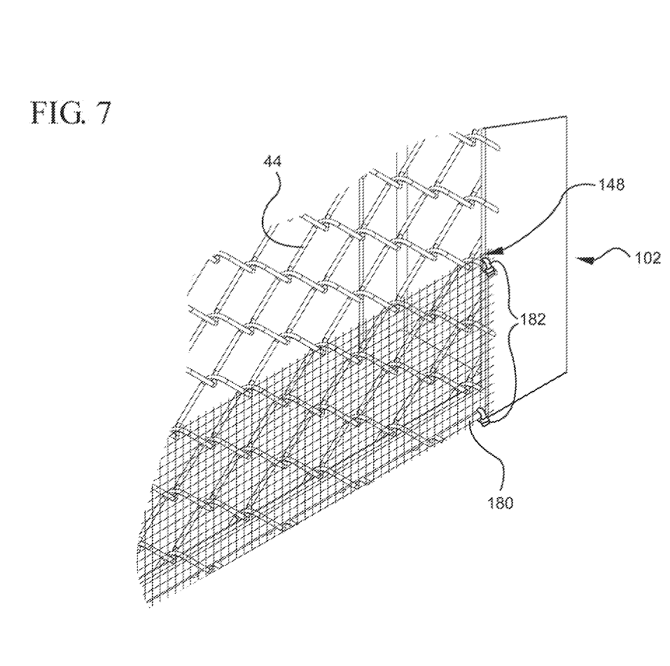

In addition to the above configurations, as illustrated in FIG. 7, an additional screen fabric 180 of a quarter inch nylon grid, eight inches in height, having a same width as the screen (only part of which is illustrated), e.g., seventy five or one hundred and fifty inches, can be located at the bottom of the screen 44. This additional screen 180 can be tied to opposing ends 146, 148 of the screen 44 with zip-ties, e.g., tie 182, of the type found in hardware stores. This additional screen material 180 can prevent smaller wildlife from passing through the screen assembly 10.

Reference will now be made to FIGS. 8A-8C, adapted from the referenced Lill patent, and which are directed to the clamp structures 108, 110 (FIG. 4E) in a top installation view. The clamps 108, 110 are mounted on a pivot 200. As best appreciated in FIG. 8A, the pivot 200 is positioned in openings 202, 204 which are co-axially aligned along a first axis 206 when the clamp is formed. The pivot 200 includes a threaded opening 208, and the axis of the threaded opening is perpendicular to the first axis 206. The clamp includes first and second post contacts 210, 212. These are integrally connected by a transition bend 214 in the plate which forms the clamp.

The angular displacement 216 (FIGS. 8A-B) of the contact members 210, 212, when first positioned at the inner surface 218 of the I-beam vertical flanges 104, 106 (FIGS. 4A, 8B-C), is sufficiently positioned away from the interior surface 218, within the c-channels 136, 138, so as to minimize friction against the posts 100, 102 and between the posts 100, 102 and the rear facing surfaces 43, 220 of the respective top rails 16, 18 (see FIG. 1D).

The bolts 96, 98 are inserted through selected guardrail slots 88-94 and engage the threaded opening 208 of the respective pivot member 200. The relationship between the contact members 210, 212 (not visible in FIGS. 8B, 8C), and the I-beam inner surface 218 is typically as it appears in FIG. 8B at the point of initial assembly.

As the bolts 96, 98 are drawn up in the threaded hole by an operator via a torque wrench 224, the transition bend 214 of the clamps 108, 110 engages the inner facing surface 220 of the rail vertical members 24, 26. As the bolts are further threaded into the opening 208 (FIG. 8C), the clamps 108, 110 rotate in the direction 222, along angular displacement 216, until the contact members 210, 212 reach the I-beam interior surface 218. The screen assembly 10 is now secured to the guardrail assembly 14.

The present invention may be embodied in other specific forms without departing from its spirit or essential characteristics. The described embodiments are to be considered in all respects only as illustrative and not as restrictive. The scope of the invention is, therefore, indicated by the appended claims. All changes that come within the meaning and range of equivalency of the claim are to be embraced within their scope.

We claim:

1. A guardrail screen assembly connectable to a guardrail assembly, the screen assembly comprising:
at least one top rail member;
guardrail attachment members for attaching opposing ends of the at least one top rail member to opposing guardrail posts;
structure which positions a bottom end of the screen member adjacent to the ground; and
a screen member, attached to said at least one top rail member and said structure which positions the bottom end of the screen member adjacent to the ground, for preventing debris and animals from traveling to and from a roadway side of the guardrail assembly.

2. The screen assembly of claim 1 wherein the structure which positions the bottom end of the screen member adjacent to the ground is a bottom rail.

3. The screen assembly of claim 3, wherein the guardrail attachment members are guardrail clamp means.

4. The screen assembly of claim 3, wherein:
the guardrail clamp means includes a bolt, which passes through a guardrail-slot in the top rail; and
plural contact members which simultaneously move either towards or away from a guardrail post surface, so as to grip or release the guardrail post surface, by turning the bolt.

5. A guardrail configuration including a guardrail and the guardrail screen assembly of claim 3, wherein the guardrail clamp means includes a bolt, which passes through a guardrail-slot in the top rail, matched with a receiving slot in an opposing guardrail post.

6. The screen assembly of claim 1, further comprising:
screen attachment members for attaching said screen to said at least one top rail member.

7. The screen assembly of claim 6, wherein:
said screen attachment members are clips, each containing a hook.

8. The screen assembly of claim 7, wherein each hook is U-shaped.

9. The screen assembly of claim 8, wherein each clip hook contains a T-joint which fits into a respective clip-slot in a body member in the at least one top rail member.

10. The screen assembly of claim 8, wherein the T-joint extends at an acute angle to an elongated member extending from the hook.

11. The screen assembly of claim 9, wherein the at least one top rail member includes two members, wherein the two top rail members are left-handed and right-handed rails, wherein at least one of the clip-slots in the left-handed rail aligns with, and is shaped differently than, at least one clip-slot in the right-handed rail.

12. The screen assembly of claim 11, wherein the two top rail members each have a top flange, the top flanges capable of overlapping for connecting the two top rail members.

13. The screen assembly of claim 12, wherein the flanges are substantially perpendicular to said body members.

14. The screen assembly of claim 12, wherein the flange members are connected through flange-slots which align when the flange members are positioned against each other.

15. The screen assembly of claim 14, wherein at least one flange-slot in the left-handed rail aligns with, and is shaped differently than, at least one flange-slot in the right-handed rail.

16. The screen assembly of claim 15, wherein the flange members are interconnected by bolts.

17. The screen assembly of claim 11, wherein the top rail members contain three or more top rail members.

18. The screen assembly of claim 1, wherein said screen is a first screen, said assembly further comprising an additional screen positioned on top of said first screen for preventing smaller debris and animals from traveling to and from a roadway side of the guardrail assembly than prevented by said first screen.

19. A guardrail configuration including a guardrail and guardrail screen assembly of claim 2, wherein:
the guardrail attachment members attach opposing ends of the at least one top rail member to opposing guardrail posts; and
the bottom rail is longer than a distance between opposing edges in c-channels of the guardrail posts.

20. The configuration of claim 19, wherein:
the screen is width-wise longer than the distance between opposing edges in the c-channels of the guardrail posts.

21. The configuration of claim 20, wherein:
the at least one top rail member is connected on an exterior side of rear flanges for the c-channels of the guardrail posts; and
opposing ends of the bottom rail are positioned within the c-channels of respective guardrail posts.

22. The configuration of claim 21, wherein:
the screen transitions from an exterior side to an interior side of the c-channel at a location which is vertically proximate to the bottom rail and vertically distal from the at least one top rail.

23. The configuration of claim 19, wherein:
the screen is height-wise longer than a predetermined height-wise distance between a ground and a bottom edge of a horizontal guardrail member of the guardrail assembly.

24. The configuration of claim 23, wherein:
the at least one top rail member is located vertically above a bottom edge of the horizontal guardrail member.
